(19) United States
(12) Patent Application Publication
(10) Pub. No.: US 2012/0155650 A1
(43) Pub. Date: Jun. 21, 2012

(54) SPEAKER ARRAY FOR VIRTUAL SURROUND RENDERING

(75) Inventor: Ulrich Horbach, Canyon Country, CA (US)

(73) Assignee: Harman International Industries, Incorporated, Northridge, CA (US)

(21) Appl. No.: 12/968,938

(22) Filed: Dec. 15, 2010

(51) Int. Cl. H04R 5/00

(52) U.S. Cl. 381/17

(57) ABSTRACT

A device and method for generation of virtual surround sound with a two-way approach is provided. The device and method employs a first order head-related model designed to resemble interaural time difference localization and inter-aural level difference localization cues in the respective frequency bands while avoiding phantom imaging and excessive coloration.

### BACKGROUND

1. Field of the Invention

The present invention relates to virtual speaker sound systems, and more particularly, to digital signal processing and speaker arrays to render rear surround channels.

2. Related Art

Typically, playing back surround sounds with only a few speakers have employed spatial enhancement techniques. The spatial enhancement techniques that allow playing back surround sound from few loudspeakers arranged in front of the listener are presently available from many different vendors. Example of such applications include 3D sound reproduction in home theatre systems where no rear speakers need to be installed and surround movie and computer game rendering using small transducers integrated into multimedia monitors or laptops. Usually, the listening experience is less than compelling, as apparent problems arise like (i) very narrow sweet spots that do not even allow larger head movements, (ii) strong imaging and tonal distortion off axis and (iii) phasiness and ear pressure felt while listeners turn their head around.

One approach for providing surround sound with only a few speakers employs multiway crosstalk canceller methods during the spatial enhancements. However, this approach requires high order inverse filter matrices with the aim to generate exact ear signals based on accurate head models, which results in degraded sound quality off axis where the listener's head is not at the exact intended position.

A signal processing approach has also been applied where a conventional crosstalk canceller circuit is used prior to crossover filters that connect to two pairs of transducers. This approach has limited success because the crosstalk canceller filters are not optimized for either of the transducer pairs.

Accordingly, a need exists for a speaker array that enables virtual surround rendering and that improves the playing back of surround sound. In particular, it is desirable to improve both the robustness and off-axis coloration of the virtual surround sound.

### SUMMARY

In view of the above, a digital signal processor is provided to process a stereo or surround sound audio signal rendering virtual surround. The process uses only speakers arranged in front of a listener and results in virtual surround sound that is robust to head movements and has low off-axis coloration. The digital signal processor renders to a speaker array rear surround channels with extended width and depth of stereo front channels by employing crossover circuits with first order head-related filters, an upmixing matrix and an array of delay lines to generate early reflections. It is to be understood that the features mentioned above and those yet to be explained below may be used not only in the respective combinations indicated but also in other combinations or in isolation without departing from the scope of the invention.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The description below may be better understood by reference to the following figures. The components in the figures are not necessarily to scale, emphasis instead being placed upon illustrating the principles of the invention. In the figures, like reference numerals designate corresponding parts throughout the different views.

FIG. 1 is a diagram of speaker array in accordance with one example of an implementation of the invention.

FIG. 2 is a simplified block diagram of digital signal processor in accordance with one example of an implementation of the invention.

FIG. 3 is a block diagram of one example of an implementation of a five channel surround renderer located in the digital signal processor of FIG. 2 and coupled to the speaker array of FIG. 1.

FIG. 4 is a block diagram of one example of a surround renderer that may be utilized in connection with the five channel surround renderer of FIG. 3.

FIG. 5 is a graph of the summed responses at a center position and twelve degrees off axis of the five channel surround renderer of FIG. 3.

FIG. 6 is a block diagram of an example of the 2-in 4-out upmixer of FIG. 3.

FIG. 7 is a graph of the output of the shelving filter of FIG. 6 for early reflections.

FIG. 8 is a flow diagram illustrating example steps for virtual surround rendering in accordance with one example of an implementation of the invention.

### DETAILED DESCRIPTION

It is to be understood that the following description of various examples is given only for the purpose of illustration and is not to be taken in a limiting sense. The partitioning of examples in function blocks, modules or units shown in the drawings is not to be construed as indicating that these function blocks, modules or units are necessarily implemented as physically separate units. Functional blocks, modules or units shown or described may be implemented as separate units, circuits, chips, functions, modules, or circuit elements. One or more functional blocks or units may also be implemented in a common circuit, chip, circuit element or unit.

In FIG. 1, a diagram 100 of speaker array or soundbar 102 in accordance with one example of an implementation of the invention is depicted. The speaker array 102 may have a two or more speakers, such as speakers and associated transducers 104, 106, 108, and 110. The transducers may be two small inner transducers 106 and 108 and two larger outer transducers 104 and 110. The speaker array 102 is typically placed in front of a listener. An example mounting for the speaker array is above or below a television, such as a flat screen television.

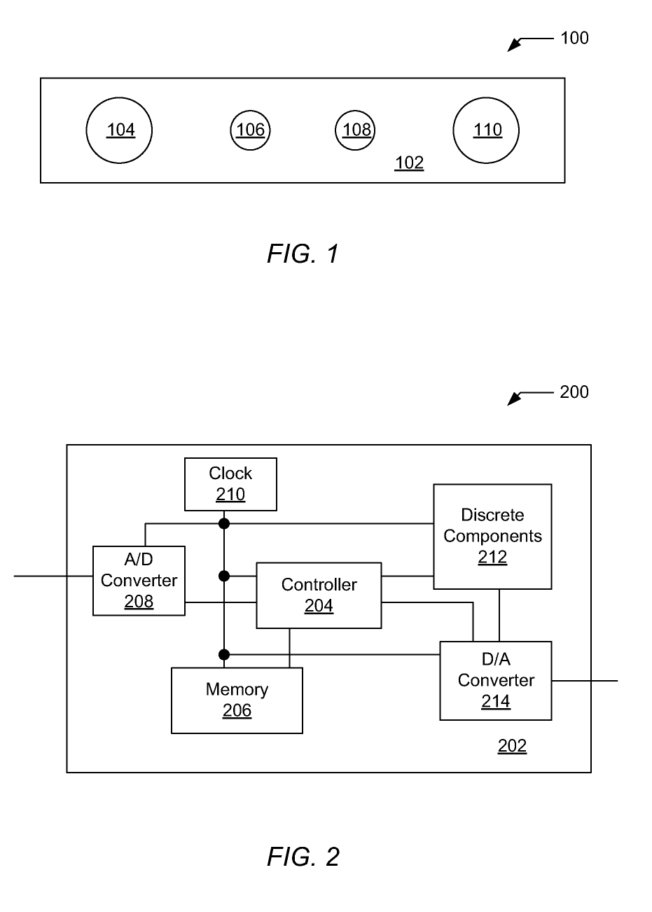

Turning to FIG. 2, a simplified block diagram 200 of one example of a digital signal processor (DSP) 202 that may be implemented in accordance with the invention is shown. The digital signal processor may have a controller 204 coupled to one or more memories, such as memory 206, analog-to-digital (A/D) converters, such as 208, clock 210, discrete components 212, and digital-to-analog (D/A) converters 214. One or more analog signals may be received by the A/D converter 208 and converted into digital signals that are processed by controller 204, memory 206 and discrete components 212. The processed signal is output through the D/A converters 214 and may be further amplified or passed to other devices, such as soundbar 102.

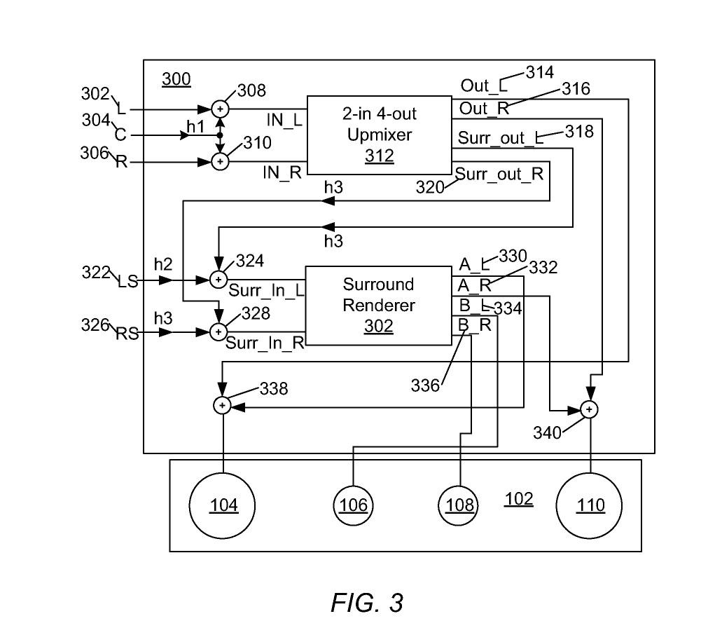

In FIG. 3, a block diagram 300 of one example a virtual surround sound processor (VSSP) 202 is illustrated. The illustrated VSSP 202 has a four channel surround renderer 302 that may be implemented in the DSP 202 of FIG. 2 and coupled to a speaker array 102 of FIG. 1. The VSSP 202 may have connectors for accepting left channel L 302, center channel C 304, right channel R 306 audio. The audio from the center channel C 304 is combined with the left channel L 302 by combiner 308 and the right channel R 306 by combiner 310. The output from combiners 308 and 310 are passed to a 2-in 4-out upmixer 312. The output of the 2-in 4-out upmixer 312 is four output signals: Out_L 314, Out_R 316, Surr_out_L 318, and Surr_Out_R 320. The Surr_out_L signal 318 is combined with a left side signal 322 by combiner 324 and Surr_out_R signal 320 is combined with the right side signal 326 by combiner 328. The output from combiners 324 and 328 are passed to a surround renderer 302. The output signals from the surround renderer 302 are illustrated as A_L 330, A_R 332, B_L 334, and B_R 336. The A_L signal 330 may be combined with the Out_L signal 314 by combiner 338 and coupled to a speaker 104 in soundbar 102. The Out_R signal 316 may be combined with the A_R signal 332 by combiner 340 and coupled to speaker 110 in soundbar 102. The B_L signal 334 and B_R 336 are respectively coupled to speakers 106 and 108 in soundbar 102.

The center channel C 304 is added to left and right input channels L 302 and R 306, via an attenuation factor h₁, respectively. Typically, h1 may be set as h₁=0.4 and is approximately −8 dB in the current example. The summed signals are connected to the inputs IN_L and IN_R (output of combiners 308 and 310) of the 2-in 4-out upmixer 312, which generate main stereo outputs Out_L 314, Out_R 316, and surround outputs Surr_Out_L 318, Surr_Out_R 320. The main outputs are directly added to the signals that feed the outer transducer pair 104 and 110 via two summing nodes or combiners 338 and 340. The surround outputs of the 2-in 4-out upmixer 312 are multiplied by a factor h₃, respectively, and added by combiners 324 and 328 to the surround input channels LS 322, and RS 326, which are multiplied by scaling factors h₂. Resulting summed input signals are connected to the inputs of the surround renderer 302, which generates four signals, a first pair A_L 330 and A_R 332 connected to the outer transducer pair 104 and 110 via summing nodes (combiners 338 and 340), and a second pair B_L 334 and B_R 336, connected to the inner transducer pair 106 and 108.

Typical values for the scaling factors employed in the 2-in 4-out mixer 312 may be h₂=2.3, h₃=1.9, but other values may be used in other implementations depending on application and taste of user. In case of a computer monitor application, the outer transducers 104 and 110 may be spaced apart by (40 . . . 50) cm, the inner pair 106 and 108 by (6 . . . 10) cm. This corresponds to angular spans to the listeners head of +/−(14 . . . 17)° for the outer pair 104 and 110, and +/−(2 . . . 4)° for the inner pair 106 and 108 at a listening distance of 80 cm. In a home theatre system, where the outer transducers 104 and 110 are located at the edges of a large TV screen, the outer transducers 104 and 110 may be spaced apart by, for example, 150 cm, and the inner transducers 106 and 108 by, for example, 30 cm, leading to similar angular spans at a listening distance of 250-300 cm. The design parameters primarily depend on the angular spans and therefore may stay the same for both example applications.

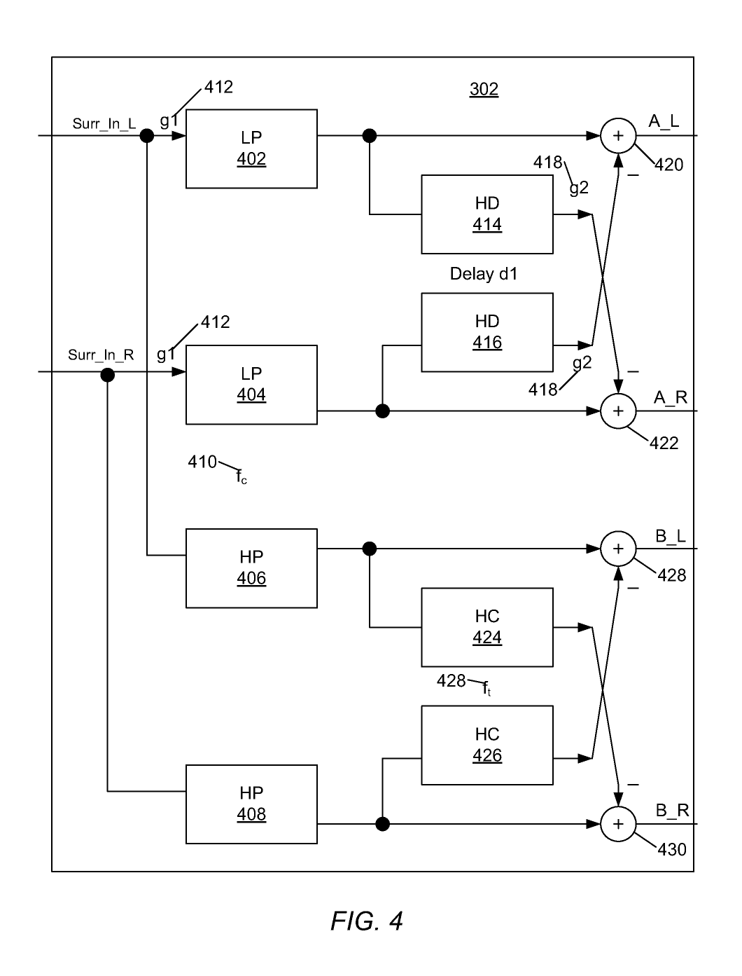

Turning to FIG. 4, a block diagram 400 of one example of an implementation of the surround renderer 302 of FIG. 3 is depicted. The two-channel input signal Surr_In_L (from combiner 324), Surr_In_R (from combiner 328) is first spectrally divided into two signal pairs by a crossover network comprising a pair of lowpass filters LP 402 and 404 and a pair of highpass filters HP 406 and 408, at a specified crossover frequency f_{c} 410. The crossover frequency f_{c} is chosen such that a simple head model is valid (typically f_{c}=500 Hz . . . 2000 Hz). The crossover filters may be low-order recursive filters, e.g., second order Butterworth (BW) filters or forth order Linkwitz-Riley (LR) filters. The lowpass section is further scaled by a factor g₁ 412.

The low-pass filtered signal pair then passes through a non-recursive (first order) crosstalk-canceller section with cross paths modeled by delay sections HD 414 and 416, representing a pure delay of d₁ samples, followed by gains g₂ 418, respectively. The cross-path outputs are subtracted from the respective direct paths by combiners 420 and 422, thereby cancelling signals that reach the left ear from the right transducer, and vice versa. At low frequencies below 700 Hz, inter-aural time differences (ITD) are prominent localization cues, whereas in the frequency range above 700 Hz, inter-aural level differences (ILD) become more dominant. At the specified listening angles, the path differences in the crosstalk paths correspond to delay values of d₁=(4 . . . 8) samples at a sampling rate of 48 kHz.

The high-pass filtered signal pair is processed by a second crosstalk-canceller section with first order lowpass filters HC 424 and 426 in the cross paths, which are characterized by a −3 dB cutoff frequency fₜ 428. Empirically determined values for HC 424 and 426 are fₜ=(3 . . . 4) kHz in the current implementation. No further delay or gain parameters are required in this section. The output of HC 424 is subtracted from the output of HP 408 by combiner 430 and results in output signal B_R. Similarly, the output of HC 426 is subtracted from the output of HP 406 by combiner 428 and results in output signal B_L.

With the described two-way approach, first order head-related models have been used that resemble ITD and ILD localization cues in the respective frequency bands. Thereby, high order head-related filters as taught in the prior art have been avoided, resulting in less off-axis coloration, phasiness and unpleasant feeling of ear pressure.

A useful range for the cross path gain factor is typically g₂=(0.3 . . . 0.9). Values close to one result in maximum separation (virtual images along the axis across the listener's ears) but require maximum bass boost, the amount of which can be set by choice of gain factor g₁. A typical design example for a computer monitor system may be:

LP, HP=second order BW sections, f_{c}=800 Hz

g₁=−3.0,

HD=frequency response of delay d₁=4 samples,

g₂=0.7,

HC=1^{st} oder lowpass, fₜ=3.5 kHz.

The frequency response at the center position, with mono input, is

g₁·LP·(1−g₂·HD)+HP·(1−HC).

At an off-axis position, an additional path length difference HD₁ between left and right outer transducers leads to the frequency response formula:

g₁·LP·(1·g₂·HD)·(1+HD₁)/2+HP·(1−HC).

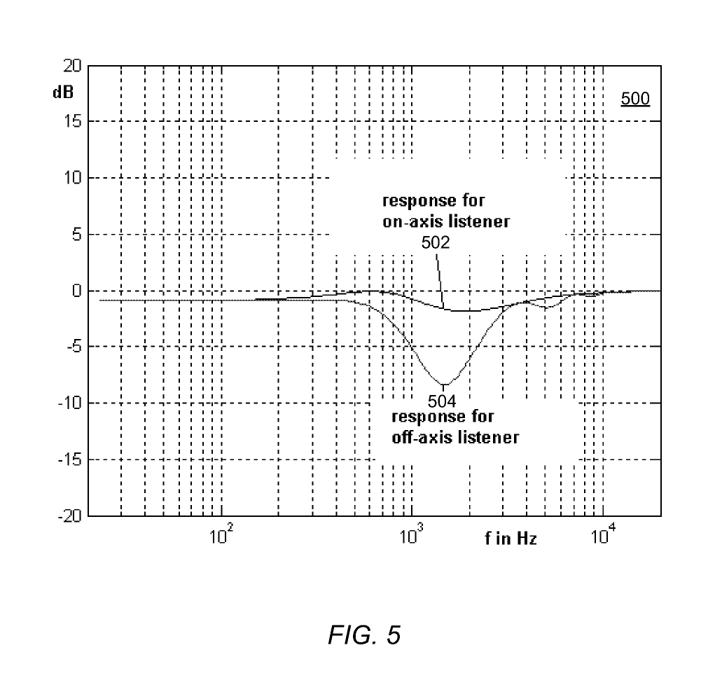

In FIG. 5, a graph 500 of the summed responses at a center position and twelve degrees off axis of the five channel surround renderer 302 (FIG. 3), is shown in accordance with one example of an implementation of the invention. At an assumed off-axis angle of 12° (resulting path length difference between left and right outer transducers HD₁=13 samples delay), the results shown in graph 500 were obtained with the on-axis response 502 being sufficiently flat and requiring no further equalization, while the off-axis response 504 only exhibits an interference dip around 1.5 kHz, which is not strongly perceived as coloration and further masked by the main stereo signals L 302, R 306, and C 304.

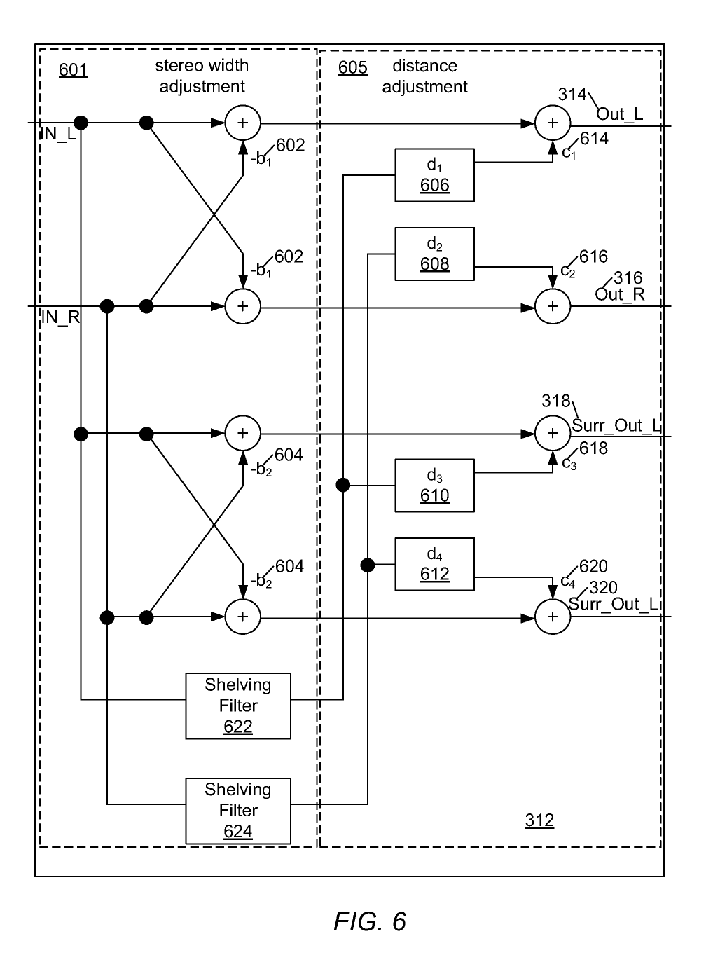

Turning to FIG. 6, a block diagram 600 of the 2-in 4-out upmixer 312 of FIG. 3 is depicted. The purpose of the 2-in 4-out upmixer 312 is to provide extended stereo width and adjustable perceived distance of the frontal sound stage, and create an enhanced spatial experience for the case of two-channel-only signal source (traditional signal source).

Stereo width adjustment may be accomplished in the stereo width adjustment section 601 with two linear 2×2 matrices with negative cross coefficients b₁ 602 for the main stereo pair Out_L 314, Out_R 316, and b₂ 604 for the virtual surround pair Surr_Out_L 318, Surr_Out_R 320, respectively. The parameter's useful range is the interval [0 . . . 1], with maximum separation for values close to one. Chosen values for the current example implementation are b₁=0.04, b₂=0.33.

Distance of the perceived sound stage may be increased beyond the speaker base by the addition of discrete reflected energy in the distance adjustment section 605. The higher the amplitude of reflections and the closer the reflections are to the direct sound (smaller delay values), the more distant the sound may be perceived. In the current example, four reflections (delayed replica of the direct sound) have been created and added to the four outputs of the 2-in 4-out upmixer 312. Parameters are the four delay values (d₁ 606, d₂ 608, d₃ 610, and d₄ 612) and their respective amplitudes (c1 614, c2 616, c3 618, c4 620). Sufficient decorrelation between the reflected signals may be achieved by assigning random values, thereby avoiding phantom imaging (merging of two or more reflections into one) and excessive coloration. An example parameter set for the current implementation may be c₁=0.62, c₂=0.50, c₃=0.71, c₄=0.5 (corresponding to −4 dB, −6 dB, −3 dB and −5 dB, respectively) and d₁=564, d₂=494, d₃=776, d₄=917 samples.

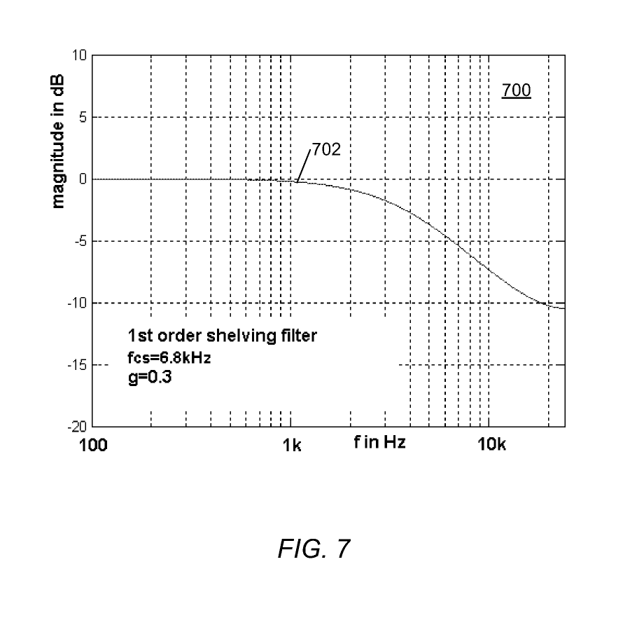

Further, a pair of first order high-shelving filters 622 and 624 may be inserted into the reflection path to simulate natural wall absorption and attenuate transients in the simulated ambient sound field. Typical parameters for the high-shelving filters 622 and 624 are depicted in FIG. 7. In FIG. 7, a graph 700 of the output 702 of the shelving filter 622 and 624 of FIG. 6 for early reflections is shown.

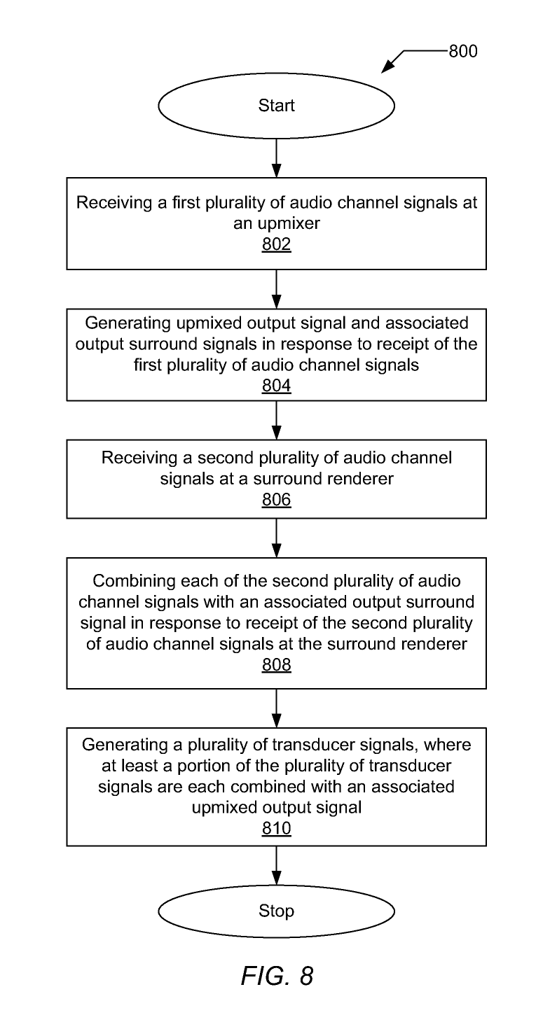

Turning to FIG. 8, a flow diagram 800 of the steps for virtual surround rendering in accordance with one example of an implementation of the invention is shown. A plurality of audio signals, such as IN_L and IN_R, are received at the 2-in 4-out upmixer 312 (802). The 2-in 4-out upmixer 312 generates upmixed output signals, such as Out_L 314 and Out_R 316, and associated output surround signals, such as Surr_out_L 318 and Surr_out_R 320, in response to receipt of the first plurality of audio channel signals (804). A second plurality of audio channel signals, such as LS 322 and RS 326, are received at the surround renderer 302 (806). Each of the second plurality of audio channel signals is combined with an associated output surround signal in response to receipt of the second plurality of audio channel signals at the surround renderer 302 by combiners 324 and 328 (808). A plurality of transducer signals are generated as output of the surround renderer 302, such as B_L 334 and B_R 336, and a portion of the plurality of transducer signals are combined with associated upmixed output signals by combiners to generate additional transducer signals, such as A_L 330 being combined with Out_L 314, and A_R 332 being combined with Out_R 316, by combiners 338 and 340 (810), respectively.

The methods described with respect to FIG. 8 may include additional steps or modules that are commonly performed during signal processing, such as moving data within memory and generating timing signals. The steps of the depicted diagrams of FIG. 8 may also be performed with more steps or functions or in parallel.

It will be understood, and is appreciated by persons skilled in the art, that one or more processes, sub-processes, or process steps or modules described in connection with FIG. 8 may be performed by hardware and/or software. If the process is performed by software, the software may reside in software memory (not shown) in a suitable electronic processing component or system such as, one or more of the functional components or modules schematically depicted or identified in FIGS. 1-7. The software in software memory may include an ordered listing of executable instructions for implementing logical functions (that is, “logic” that may be implemented either in digital form such as digital circuitry or source code), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any tangible means that may contain, store or communicate the program for use by or in connection with the instruction execution system, apparatus, or device. The computer readable medium may selectively be, for example, but is not limited to, an electronic, magnetic, optical, electromagnetic, infrared, or semiconductor system, apparatus or device. More specific examples, but nonetheless a non-exhaustive list, of computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper or another suitable medium upon which the program is printed and captured from and then compiled, interpreted or otherwise processed in a suitable manner if necessary, and then stored in a computer memory.

The foregoing description of implementations has been presented for purposes of illustration and description. It is not exhaustive and does not limit the claimed inventions to the precise form disclosed. Modifications and variations are possible in light of the above description or may be acquired from practicing examples of the invention. The claims and their equivalents define the scope of the invention.

What is claimed is:

1. A virtual surround rendering audio device comprising:
an upmixer that receives a first plurality of audio channel signals and generates upmixed output signals and associated output surround signals; and
a surround renderer that receives a second plurality of audio channel signals, where each of the second plurality of audio signals is combined with an associated output surround signal and generates a plurality of transducer signals, where at least a portion of the plurality of transducer signals are each combined with an associated upmixed output signal.

2. The virtual surround rendering audio device of claim 1, where the first plurality of audio channel signals includes at least a left channel signal, a right channel signal, and a center channel signal.

3. The virtual surround rendering audio device of claim 2, where the center channel signal is combined with both the right channel signal and left channel signal.

4. The virtual surround rendering audio device of claim 1, where the upmixer includes a stereo width adjustment section and a distance adjustment section.

5. The virtual surround rendering audio device of claim 4, where the stereo width adjustment section includes a first negative cross coefficients parameter.

6. The virtual surround rendering audio device of claim 5, where the stereo width adjustment section further includes a second negative cross coefficients parameter associated with the associated output surround signals.

7. The virtual surround rendering audio device of claim 5, where the stereo width adjustment section further includes a shelf filter associated with each of the plurality of audio channel signals received at the upmixer.

8. The virtual surround rendering audio device of claim 4, where the distance adjustment section includes delay parameters associated with each of the output signals and associated output surround signals.

9. The virtual surround rendering audio device of claim 8 where each of the delays has a respective amplitude parameter.

10. The virtual surround rendering audio device of claim 1, where the surround renderer further includes each of the output surround signals being split and passed through a low-pass filter and a high pass.

11. The virtual surround rendering audio device of claim 10, further includes a first plurality of combiner that subtracts a delayed output from each of the other low pass-filters from the output of a first low-pass filter.

12. The virtual surround rendering audio device of claim 10, further includes a second plurality of combiners that subtracts a cross-talk canceller output from each of the high pass filters from the output of a first high pass filter.

13. The virtual surround rendering audio device of claim 12, where the cross-over frequency of the cross-talk canceller is in the range of 500 Hz to 2000 Hz.

14. A method of virtual surround rendering comprising, the steps of:
receiving a first plurality of audio channel signals at an upmixer;
generating upmixed output signals and associated output surround signals in response to receipt of the first plurality of audio channel signals;
receiving a second plurality of audio channel signals at a surround renderer;
combining each of the second plurality of audio channel signals with an associated output surround signal in response to receipt of the second plurality of audio channel signals at the surround renderer; and
generating a plurality of transducer signals, where at least a portion of the plurality of transducer signals are each combined with an associated upmixed output signal.

15. The method of virtual surround rendering of claim 14, where receipt of the first plurality of audio channel signals includes receiving at least a left channel signal, a right channel signal, and a center channel signal.

16. The method of virtual surround rendering of claim 15, includes combining the center channel signal with both the right channel signal and left channel signal.

17. The method of virtual surround rendering of claim 14, where the upmixer includes a stereo width adjustment section and a distance adjustment section.

18. The method of virtual surround rendering of claim 17, includes applying a first negative cross coefficients parameter to the first plurality of audio channel signals in the width adjustment section.

19. The method of virtual surround rendering of claim 18, where the stereo width adjustment section further includes applying a second negative cross coefficients parameter associated with the associated output surround signals.

20. The method of virtual surround rendering of claim 18, where the stereo width adjustment section further includes filtering each of the plurality of audio channel signals received at the upmixer with a shelf filter associated with a shelf filter associated.

21. The method of virtual surround rendering of claim 17, where the distance adjustment section includes delaying each of the output signals and associated output surround signals with delay parameters.

22. The method of virtual surround rendering of claim 21 where each of the delays has a respective amplitude parameter.

23. The method of virtual surround rendering of claim 14, where the surround renderer further includes filtering each of the output surround signals after being split through a low-pass filter and a high pass filter.

24. The method of virtual surround rendering of claim 23, further includes subtracting with a first plurality of combiner a delayed output from each of the other low pass-filters from the output of a first low-pass filter.

25. The virtual surround rendering of claim 23, further includes subtracting with a second plurality of combiners a cross-talk canceller output from each of the high pass filters from the output of a first high pass filter.

26. The virtual surround rendering of claim 25, where the cross-over frequency of the cross-talk canceller is in the range of 500 Hz to 2000 Hz.
